(19) United States
(12) Patent Application Publication
(10) Pub. No.: US 2026/0042379 A1
(43) Pub. Date: Feb. 12, 2026

(54) BATTERY TEMPERATURE CONTROL SYSTEM AND VEHICLE

(71) Applicant: SUBARU CORPORATION, Tokyo (JP)

(72) Inventor: Masayuki YAMANE, Tokyo (JP)

(21) Appl. No.: 19/276,206

(22) Filed: Jul. 22, 2025

(30) Foreign Application Priority Data
Aug. 9, 2024 (JP) 2024-134046

(51) Int. Cl. B60L 58/24; B60L 58/12; H01M 10/625; H01M 10/633

(52) U.S. Cl. CPC B60L 58/24; B60L 58/12; H01M 10/625; H01M 10/633; B60L 2260/52; B60L 2260/54

(57) ABSTRACT

A battery temperature control system to be applied to a vehicle includes a battery, an auxiliary device, and a processor. The auxiliary device includes an air-conditioner. The processor is configured to determine whether the vehicle is in a non-travelable state or a travel unnecessary state. The processor is configured to, upon detecting that the vehicle is in the non-travelable state or the travel unnecessary state, calculate first energy necessary to drive the auxiliary device, and adjust a temperature of the battery to a first battery temperature appropriate for the battery to output the first energy.

### CROSS-REFERENCE TO RELATED APPLICATIONS

The present application claims priority from Japanese Patent Application No. 2024-134046 filed on Aug. 9, 2024, the entire contents of which are hereby incorporated by reference.

### BACKGROUND

The disclosure relates to a battery temperature control system for a vehicle and to a vehicle.

An electric vehicle includes a large-capacity battery that supplies electric energy necessary to cause the vehicle to travel and to drive various kinds of auxiliary devices provided in the vehicle. The battery is adjusted in temperature to, for example, 20 to 30° C. that is within an appropriate temperature range allowing the battery to efficiently output the electric energy necessary to cause the vehicle to travel. Reference is made to Japanese Unexamined Patent Application Publication No. 2024-083451.

### SUMMARY

An aspect of the disclosure provides a battery temperature control system to be applied to a vehicle. The battery temperature control system includes a battery, an auxiliary device, and a processor. The auxiliary device includes an air-conditioner. The processor is configured to determine whether the vehicle is in a non-travelable state or a travel unnecessary state. The processor is configured to, upon determining that the vehicle is in the non-travelable state or the travel unnecessary state, calculate first energy necessary to drive the auxiliary device, and adjust a temperature of the battery to a first battery temperature appropriate for the battery to output the first energy.

An aspect of the disclosure provides a vehicle comprising a battery temperature control system. The battery temperature control system includes a battery, an auxiliary device, and a processor. The auxiliary device includes an air-conditioner. The processor is configured to determine whether the vehicle is in a non-travelable state or a travel unnecessary state. The processor is configured to, upon determining that the vehicle is in the non-travelable state or the travel unnecessary state, calculate first energy necessary to drive the auxiliary device, and adjust a temperature of the battery to a first battery temperature appropriate for the battery to output the first energy.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating an exemplary configuration of a vehicle including a battery temperature control system according to one example embodiment of the disclosure.

FIG. 2 is a flowchart of exemplary control processing to be performed by the battery temperature control system illustrated in FIG. 1.

FIG. 3 is a block diagram illustrating a modification example of the configuration of the vehicle including the battery temperature control system illustrated in FIG. 1.

FIG. 4 is a flowchart of exemplary control processing to be performed by a battery temperature control system according to a modification example of the disclosure.

FIG. 5 is a flowchart of another exemplary control processing to be performed by the battery temperature control system according to the modification example of the disclosure.

### DETAILED DESCRIPTION

For constant travel of an electric vehicle, a battery temperature is constantly adjusted within an appropriate temperature range in which the battery is allowed to output electric energy necessary to drive a driving unit. According to an existing technique, even in a condition where it is difficult for a vehicle to travel due to stalling in the snow in an arctic area, for example, the battery temperature is adjusted within the above-described temperature range to achieve constant travel of the vehicle.

However, an appropriate temperature at which the battery is allowed to output the electric energy necessary to drive the driving unit is a relatively high temperature. If the battery temperature adjustment within the above-described temperature range is continuously performed in an arctic area, electric power consumption of the battery largely increases. For example, if the condition where it is difficult for the vehicle to travel lasts for a long time, the battery temperature adjustment consumes a large amount of electric power of the battery. This can make it difficult to secure the electric energy necessary to drive an auxiliary device such as an air-conditioner according to the intention of an occupant of the vehicle, resulting in prolonged stalling of the vehicle that could make the occupant feel uncomfortable.

It is desirable, in a condition where it is difficult or unnecessary for a vehicle to travel, to adjust a battery temperature within a temperature range in which the battery is allowed to output necessary electric energy as appropriate without performing a battery temperature adjustment based on the electric energy necessary to cause the vehicle to travel, to thereby reduce electric power consumption of the battery and ensure comfort of an occupant of the vehicle even at the occurrence of prolonged stalling of the vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

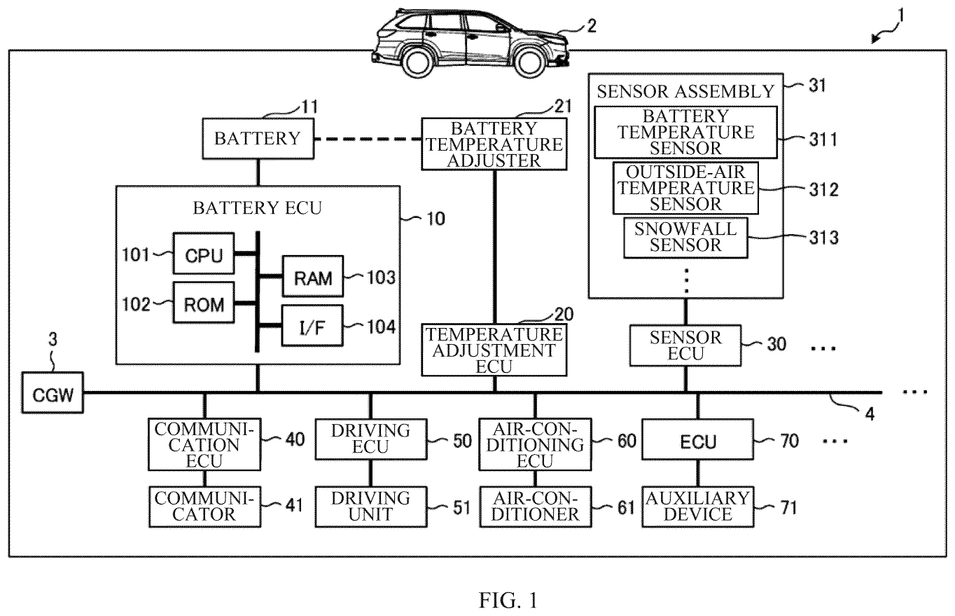

As illustrated in FIG. 1, a battery temperature control system 1 according to an example embodiment of the disclosure may include control target devices mounted in a vehicle 2 and electronic control units (ECUs) that control these control target devices. The control target devices and the ECUs may be communicably coupled to each other via an in-vehicle network 4, such as a controller area network (CAN) or a local interconnect network (LIN), and a relay device, such as a central gateway (CGW) 3. In some embodiments, the CGW 3 may not be provided, and the ECUs may be configured to communicate with each other directly or indirectly.

Each of the ECUs in the battery temperature control system 1 may output data on the state of operation of a corresponding one of the control target devices to the in-vehicle network 4. Further, each of the ECUs may control the operation of the corresponding one of the control target devices, based on data received from the other ECUs via the in-vehicle network 4.

Each of the ECUs may include a processor, such as a central processing unit (CPU) or a micro processing unit (MPU), and cause the processor to execute various kinds of processing. Further, each of the ECUs may include a volatile memory, such as a random-access memory (RAM), that temporarily processes data to be used by the processor, or a non-volatile memory, such as a read only memory (ROM), that stores data such as a program to be executed by the processor or another device. In some embodiments, a part or the entirety of the operation to be performed by each of the ECUs may be implemented by hardware, such as an application specific integrated circuit (ASIC), a field-programmable gate array (FPGA), or a graphics processing unit (GPU).

In FIG. 1, some of the ECUs are illustrated, including a battery ECU 10, a temperature adjustment ECU 20, a sensor ECU 30, a communication ECU 40, a driving ECU 50, an air-conditioning ECU 60, and other ECUs 70. Further, in FIG. 1, some of the control target devices are illustrated, including a battery 11, a battery temperature adjuster 21, a sensor assembly 31, a communicator 41, a driving unit 51, an air-conditioner 61, and other auxiliary devices 71. In one embodiment, the battery ECU 10, the temperature adjustment ECU 20, and the battery temperature adjuster 21 may serve as a “processor”. Note that illustration and detailed description of the ECUs and the control target devices in the present example embodiment that are not relevant to the functionality and operation of the battery temperature control system 1 are not given herein even if they are included in the battery temperature control system 1.

As illustrated in FIG. 1, the battery ECU 10 may include a CPU 101, a ROM 102, a RAM 103, and an interface (I/F) 104. The battery ECU 10 may cause the CPU 101 to execute various kinds of processing, based on programs held in the ROM 102, to thereby control the battery 11 and the other components. The ROM 102 provided as a non-volatile memory may hold a program to be used in controlling the battery 11 and the other components, based on the data received from the other ECUs via the in-vehicle network 4 and various kinds of data necessary to execute the program.

The RAM 103 provided as a volatile memory may be used as a work area for the CPU 101 performing various kinds of processing. Various kinds of data received from each of the ECUs may be temporarily recorded in the RAM 103, as needed.

The interface 104 may control input or output of various kinds of data and control signals to be used in the battery ECU 10. In other words, the interface 104 may receive data sent from each of the ECUs to the in-vehicle network 4. Further, the interface 104 may send a control signal generated by the CPU 101 to a destination appropriate to the content of the control.

The CPU 101 may read the program held in the ROM 102 and load the program into a memory such as the RAM 103, to thereby execute the control in the battery temperature control system 1.

Although not illustrated in the drawings and not described in the following description, like the battery ECU 10, each of the temperature adjustment ECU 20, the sensor ECU 30, the communication ECU 40, the driving ECU 50, the air-conditioning ECU 60, and the other ECUs 70 may also include a CPU, a ROM, a RAM, and an interface, and may control the corresponding control target device by causing the CPU to perform various kinds of processing, based on programs held in the ROM.

The battery ECU 10 may hold an electric power consumption map. The electric power consumption map may be information on a temperature or temperature range in which the battery 11 is allowed to output electric energy necessary to drive in-vehicle devices such as the control target devices. The electric energy that the battery 11 is able to output may vary depending on the temperature: As the temperature of the battery 11 decreases, an internal resistance may increase and the electric energy that the battery 11 is able to output may decrease accordingly. Note that an application of the electric power consumption map will be described in detail later.

The battery 11 may output the electric energy under the control by the battery ECU 10. The battery 11 mounted in the vehicle 2 may be, for example but not limited to, a lithium-ion battery. The battery 11 may be charged with electric power from an external device, such as a rapid charger, disposed outside the vehicle 2. Each of the ECUs may send data on the electric energy necessary to drive the corresponding control target device to the in-vehicle network 4. The battery ECU 10 may cause the battery 11 to output the electric energy necessary for the control target device by controlling the battery 11, based on the data received from each of the ECUs via the in-vehicle network 4.

The battery temperature adjuster 21 may adjust the temperature of the battery 11. The battery temperature adjuster 21 may adjust the temperature of the battery 11 to a temperature within the appropriate temperature range in which the battery 11 is allowed to output the electric energy necessary to drive the driving unit 51 to be described later or the auxiliary devices 71 including the air-conditioner 61 and other devices mounted in the vehicle 2. Cooling and heating the battery 11 by the battery temperature adjuster 21 may be controlled taking into consideration an influence of an outside surrounding temperature on the battery 11.

In some embodiments, the battery temperature adjuster 21 may be: a non-illustrated heating-medium circuit or a non-illustrated cooling-medium circuit that is a part of the air-conditioner 61 having a flow passage in which heat exchange is possible between the battery 11 and the heating medium or the a cooling medium; a non-illustrated cooling air passage configured to adjust the flow amount of running air to cool the battery 11; a non-illustrated radiator fan that directly cools the battery 11; or a non-illustrated heater that directly heats the battery 11. The battery temperature adjuster 21 may be one of the control target devices that is configured to heat and cool the battery 11 under the control by the corresponding ECU mounted in the vehicle 2, or a combination thereof. The ECU that controls these control target devices may serve as the temperature adjustment ECU 20. The battery temperature adjuster 21 that adjusts the temperature of the battery 11 may also be driven by the electric energy received from the battery 11. Note that a detailed description is not given herein of the control of these control target devices described above as examples of the battery temperature adjuster 21.

The sensor ECU 30 may send detection data obtained by the sensor assembly 31 to the in-vehicle network 4. In the present example embodiment, the sensor assembly 31 may include a battery temperature sensor 311 that detects the temperature of the battery 11, an outside-air temperature sensor 312 that detects an outside air temperature, and a snowfall sensor 313 that detects whether the snow covering a roof of the vehicle 2 is greater than a predetermined amount. The battery ECU 10 may determine whether the vehicle 2 is in a non-travelable state, based on detection data of the snowfall sensor 313 received via the in-vehicle network 4. The term “non-travelable state” used herein may refer to a state where it is difficult for the vehicle 2 to travel due to stalling in the snow, for example. The battery temperature adjuster 21 may adjust the temperature of the battery 11 while feeding back the data on the temperature of the battery 11 detected by the battery temperature sensor 311. The battery temperature sensor 311 may include, for example but not limited to, a voltage sensor, a current sensor, and a temperature sensor, and may be configured to obtain a state of charge (SOC) of the battery 11.

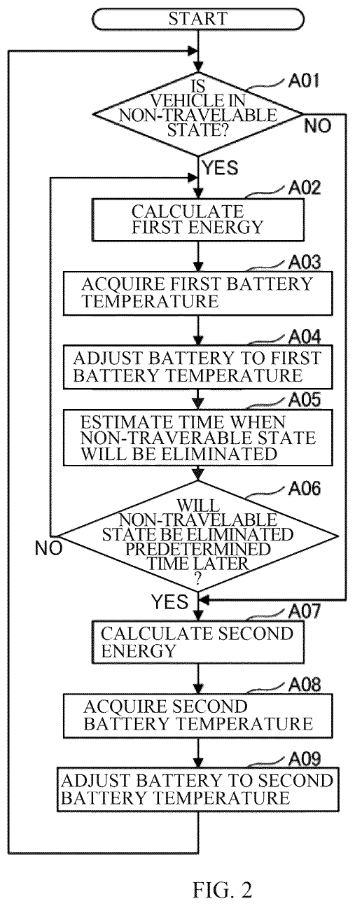

The communication ECU 40 may control the communicator 41 to establish communication between the vehicle 2 and an external device. The communicator 41 may be configured to receive at least position data of the vehicle 2, weather data, traffic congestion data, and disaster data. The communication ECU 40 may send the reception data of the communicator 41 to the in-vehicle network 4. The battery ECU 10 may determine whether the vehicle 2 is in the non-travelable state and whether the non-travelable state of the vehicle 2 will be eliminated, based on the reception data of the communicator 41 received via the in-vehicle network 4. The control will be described in detail later with reference to FIG. 2.

The driving ECU 50 may control the travel of the vehicle 2 by controlling the driving unit 51. The driving unit 51 may include, for example but not limited to, a non-illustrated accelerator pedal, a non-illustrated brake pedal, and a driving system that transmits an output of a non-illustrated motor to a non-illustrated driving wheel. The driving ECU 50 may control the driving unit 51 having such a configuration to thereby control the travel of the vehicle 2. The driving ECU 50 may send driving data on an operation of the driving unit 51 and on the electric energy necessary to drive the driving unit 51 to the in-vehicle network 4.

The air-conditioning ECU 60 may adjust a temperature inside a vehicle compartment of the vehicle 2 by controlling the air-conditioner 61. The air-conditioning ECU 60 may control the air-conditioner 61, based on settings inputted by the occupant of the vehicle 2 or detection data received from sensors. Note that a description and illustration of the sensors that acquire the detection data necessary to adjust the temperature inside the vehicle compartment of the vehicle 2 are not given herein. In the present example embodiment, the air-conditioner 61 may include, although not illustrated in the drawings, a compressor, a blower, a high-voltage heater, a circulation pump, and an electronic valve that switches a circulation passage of the cooling medium or the heating medium. The air-conditioning ECU 60 may control these control target devices to thereby adjust the temperature inside the vehicle compartment of the vehicle 2. Further, the air-conditioning ECU 60 may send data on electric energy necessary to drive these control target devices to the in-vehicle network 4.

As described above, non-limiting examples of the battery temperature adjuster 21 may include a non-illustrated heating-medium circuit of the air-conditioner 61. The heating-medium circuit may circulate the heating medium with the circulation pump, and heat the heating medium with the high-voltage heater. In the circulation passage of the heating medium, a heat exchanger that exchanges heat between the battery 11 and the heating medium may be provided. The heat exchanger may exchange heat between the heating medium flowing in the heat exchanger and the battery 11 to thereby adjust the temperature of the battery 11. In this way, the heating-medium circuit that is a part of the air-conditioner 61 may serve as the battery temperature adjuster 21 of the battery temperature control system 1. In the example embodiment where the heating-medium circuit serves as the battery temperature adjuster 21, the air-conditioning ECU 60 may serve as the temperature adjustment ECU 20.

The auxiliary devices 71 may refer to the other control target devices, not illustrated in FIG. 1, to be driven by the electric energy received from the battery 11. The communicator 41 and the air-conditioner 61 illustrated in FIG. 1 may be examples of the auxiliary devices 71. The ECU 70 may control the auxiliary devices 71. Note that the description of the present example embodiment is given provided that the control target devices to be driven by the electric energy received from the battery 11 include the driving unit 51 and the auxiliary devices 71 other than the driving unit 51.

As described above with reference to FIG. 1, the battery temperature control system 1 may include the control target devices and the ECUs that control the control target devices. Next, a description will be given, with reference to FIG. 2, of exemplary control processing to be performed by the battery temperature control system 1 according to the present example embodiment.

The battery ECU 10 may determine whether the vehicle 2 is in the non-travelable state, based on the detection data of the sensor assembly 31, the reception data of the communicator 41, and the driving data of the driving unit 51 that are received from the respective ECUs via the in-vehicle network 4 (Step A01). In some embodiments, upon detecting by the snowfall sensor 313 that the amount of the snow on the roof of the vehicle 2 is greater than the predetermined amount and determining that the driving unit 51 has not been driven for a predetermined period of time, the battery ECU 10 may determine that the vehicle 2 is in the non-travelable state due to stalling. In some embodiments, upon determining that the driving unit 51 of the vehicle 2 in a disaster area has not driven for a predetermined period of time, the battery ECU 10 may determine that the vehicle 2 is in the non-travelable state due to stalling.

Upon detecting that the vehicle 2 is in the non-travelable state (Step A01: YES), the battery ECU 10 may calculate first energy (Step A02). The term “first energy” used herein may refer to a total amount of the electric energy necessary to drive the auxiliary devices 71, excluding the driving unit 51, that are to be driven by the electric energy received from the battery 11. The battery ECU 10 may calculate, based on the data received from the respective ECUs via the in-vehicle network 4, the first energy necessary to drive the auxiliary devices 71, excluding the driving unit 51, that are to be driven.

After calculating the first energy, the battery ECU 10 may acquire a first battery temperature appropriate for the battery 11 to output the first energy (Step A03). The first battery temperature may be calculated based on the first energy as needed, or may be acquired from the electric power consumption map recorded in the battery ECU 10. After acquiring the first battery temperature, the battery ECU 10 may send data on the first battery temperature to the in-vehicle network 4. Upon receiving the data on the first battery temperature via the in-vehicle network 4, the temperature adjustment ECU 20 may adjust the temperature of the battery 11 to the first battery temperature (Step A04).

Thereafter, the battery ECU 10 may estimate a time when the non-travelable state will be eliminated, based on the reception data of the communicator 41 received via the in-vehicle network 4 (Step A05). In some embodiments, the battery ECU 10 may estimate the time, based on the weather data, the traffic congestion data, and the disaster data received by the communicator 41. In some embodiments, when the vehicle 2 is stalling in the snow in an arctic area, the battery ECU 10 may estimate the time when the snow will ease off and the vehicle 2 will be brought into a travelable state, based on the weather data. In some embodiments, the battery ECU 10 may determine the time when the non-travelable state of the vehicle 2 will be eliminated, based on the traffic congestion data and the disaster data. The method of estimating the time is not limited to the above-described methods, and the time when the non-travelable state of the vehicle 2 will be eliminated may be estimated based on the detection data of the sensor assembly 31 and the reception data of the communicator 41 by another method. In some embodiments where the time when the non-travelable state will be eliminated is estimated by another method, the sensor assembly 31 and the communicator 41 may include a sensor that receives necessary data or may have a functionality of receiving the necessary data, as appropriate.

Based on the time estimated as described above, the battery ECU 10 may determine whether the non-travelable state will be eliminated a predetermined time later (Step A06). The predetermined time may be any period of time enough to adjust the temperature of the battery 11 to a later-described second battery temperature by the time when the non-travelable state will be eliminated. In some embodiments, the predetermined time may be set to about five to ten minutes. If the battery ECU 10 determines that the non-travelable state will not be eliminated the predetermined time later (Step A06: NO), the processing may return to Step A02, and the battery ECU 10 may continue adjusting the temperature of the battery 11 to the first battery temperature that is based on the first energy.

If it is determined that the non-travelable state will be eliminated the predetermined time later (Step A06: YES) or if it is not determined that the vehicle 2 is in the non-travelable state in Step A01 (Step A01: NO), the battery ECU 10 may calculate second energy (Step A07). The term “second energy” used herein may refer to a total amount of the electric energy necessary to drive the driving unit 51 and the electric energy necessary to drive the auxiliary devices 71 that are to be driven by the electric energy received from the battery 11.

After calculating the second energy, the battery ECU 10 may acquire a second battery temperature appropriate for the battery 11 to output the second energy (Step A08). The second battery temperature may be calculated based on the second energy as needed, or may be acquired from the electric power consumption map recorded in the battery ECU 10. After acquiring the second battery temperature, the battery ECU 10 may send data on the second battery temperature to the in-vehicle network 4. Upon receiving the data on the second battery temperature via the in-vehicle network 4, the temperature adjustment ECU 20 may adjust the temperature of the battery 11 to the second battery temperature (Step A09), and the processing may return to Step A01. Thereafter, the control in Steps A01 to A09 described above may be repeated.

In adjusting the temperature of the battery 11 to the first battery temperature or the second battery temperature by the battery temperature adjuster 21, the temperature adjustment ECU 20 may cause the battery temperature adjuster 21 to adjust the temperature of the battery 11 with as little electric power as possible. For example, in an arctic area where an outside air temperature is lower than a lower limit of the temperature range of the first battery temperature, it may be expected that the temperature of the battery 11 will naturally fall below the lower limit of the first battery temperature due to influences of the outside air or surrounding devices on the temperature of the battery 11. In this case, the temperature adjustment ECU 20 may adjust the temperature of the battery 11 to a target temperature that is set at the lower limit of the first battery temperature. In contrast, in a case where it is expected that the temperature of the battery 11 will naturally fall within the temperature range of the first battery temperature due to the influences of the outside air or the surrounding devices on the temperature of the battery 11, the battery temperature adjuster 21 may refrain from adjusting the temperature of the battery 11. The same may apply to the temperature adjustment to the second battery temperature. The influences of the outside air or the surrounding devices of the battery 11 on the battery 11 may be recognized based on data obtained by the outside-air temperature sensor 312 or a non-illustrated temperature sensor provided in each of the control target devices.

Further, in adjusting the temperature of the battery 11 to the first battery temperature or the second battery temperature, the data on the electric energy necessary to drive the battery temperature adjuster 21 may be reflected on the first energy or the second energy while the data sent from the temperature adjustment ECU 20 to the in-vehicle network 4 is fed back. Based on the first energy or the second energy obtained as a result of the feedback, the first battery temperature or the second battery temperature may be acquired, and the temperature of the battery 11 may be adjusted based on the first battery temperature and the second battery temperature. Since the electric energy necessary to drive the battery temperature adjuster 21 varies depending on factors such as the outside air temperature affecting the temperature of the battery 11 and a current temperature of the battery 11, the first battery temperature may be acquired while the electric energy necessary to drive the battery temperature adjuster 21 is fed back to the first energy, based on the detection data of the outside-air temperature sensor 312 and the battery temperature sensor 311, and the temperature of the battery 11 may be adjusted to the first battery temperature thus acquired. The control of the temperature adjustment ECU 20 may apply similarly to a battery temperature control system 1A to be described later.

According to the battery temperature control system 1 of the present example embodiment described above, when it is detected that the vehicle 2 is in the non-travelable state due to stalling in the snow, for example, the temperature adjustment of the battery 11 may be performed based on the electric energy necessary to drive the auxiliary devices 71, excluding the driving unit 51, that are to be driven, without performing the temperature adjustment of the battery 11 based on the electric power necessary to drive the driving unit 51.

The temperature range in which the battery 11, which may be a lithium-ion battery, is allowed to efficiently output the electric energy necessary to cause the vehicle 2 to travel may be about 20° C. to 30° C. Accordingly, the temperature of the battery 11 of the vehicle 2 may be adjusted to a temperature (the second battery temperature) of, for example, 20° C. to 30° C., which is appropriate to output the electric energy necessary to drive the driving unit 51 and the air-conditioner 61.

Meanwhile, the electric energy necessary to drive the air-conditioner 61 or the other auxiliary devices 71 may be less than that necessary to drive the driving unit 51. Although the electric energy that the battery 11 is capable of outputting varies depending on temperature, the battery 11 may be capable of outputting the electric energy necessary to drive the air-conditioner 61 or the auxiliary devices 71 even when the temperature of the battery 11 is not within the range of the second battery temperature from 20° C. to 30° C. For example, even when the battery 11 has a temperature about −10° C. (which is an example of a temperature below the lower limit of the first battery temperature) in an arctic environment where, the battery 11 may be capable of outputting the electric energy necessary to drive the air-conditioner 61; therefore, the temperature adjustment of the battery 11 to a temperature within the range from 20° C. to 30° C. is not necessary to drive the air-conditioner 61. For example, in an arctic environment where an outside air temperature is lower than the lower limit of the first battery temperature, the electric energy necessary to adjust the temperature of the battery 11 to 20° C. (which is an example of a temperature below the lower limit of the second battery temperature) is different from the electric energy necessary to adjust the temperature of the battery 11 to −10° C. (which is an example of a temperature below the lower limit of the first battery temperature). If the temperature adjustment of the battery 11 to 20° C. is continuously performed in this condition, the electric power consumption of the battery 11 increases.

To address these concerns, the battery temperature control system 1 performs the temperature adjustment of the battery 11, based on the electric energy necessary to drive a device to be driven. This helps to reduce the electric power consumption in the temperature adjustment of the battery 11.

The method of determining whether the vehicle 2 is in the non-travelable state is not limited to the method in Step A01 described above, and the determination as to whether the vehicle 2 is in the non-travelable state may be made by another method, based on the data obtained by the sensor assembly 31, the communicator 41, the driving unit 51, and other devices. Further, in the present example embodiment, the sensor assembly 31 may include the snowfall sensor 313 as a device that determines whether the vehicle 2 is in the non-travelable state; however, in some embodiments where another method is employed to determine whether the vehicle 2 is in the non-travelable state, another sensor may be provided to detect necessary data, as needed. For example, in the determination as to whether the vehicle 2 is in the non-travelable state due to stalling in an arctic area, it may be determined whether the motor of the vehicle 2 is frozen, based on a resistance of a mirror motor, and it may be determined whether the vehicle 2 is in the non-travelable state, based on the detection data. In some embodiments, it may be determined whether the wheel is frozen by applying minute torque to the wheel, and it may be determined whether the vehicle 2 is in the non-travelable state, based on the detection data. Note that various kinds of data other than the data described above may be used to accurately determine whether the vehicle 2 is in the non-travelable state.

When it is determined that the vehicle 2 is in the non-travelable state, the control may be performed in which the temperature of the battery 11 is adjusted to a temperature at which the battery 11 is allowed to output minimum electric energy necessary to drive the auxiliary devices 71 and maintain the comfortability of the occupant of the vehicle 2, by partially regulating the output from the air-conditioner 61 or the auxiliary devices 71. This control helps to reduce the electric power to be consumed to drive the auxiliary devices 71 and adjust the temperature of the battery 11, sustaining the SOC of the battery 11 for as a long time as possible.

Further, after estimating the time when the non-travelable state will be eliminated in the control in the non-travelable state, the output of the air-conditioner 61 and the auxiliary devices 71 may be controlled based on the SOC of the battery 11, and the temperature of the battery 11 may be adjusted to a temperature at which the battery 11 is allowed to output the necessary electric energy based on the control. For example, when the vehicle 2 is stalling, the output of the auxiliary devices 71 may be controlled referring to the SOC of the battery 11 to sustain the SOC of the battery 11 until the time when the non-travelable state will be eliminated and to secure the SOC of the battery 11 enough to cause the vehicle 2 to travel from a current position to a nearest charging station. In addition, the temperature of the battery 11 may be adjusted to a temperature at which the battery 11 is allowed to output the necessary electric energy that is based on the control. This control helps to suppress running down of the battery 11, making the occupant of the vehicle 2 feel secured.

Next, a description will be given of a battery temperature control system 1A that is a modification example of the battery temperature control system 1 of the above-described example embodiment.

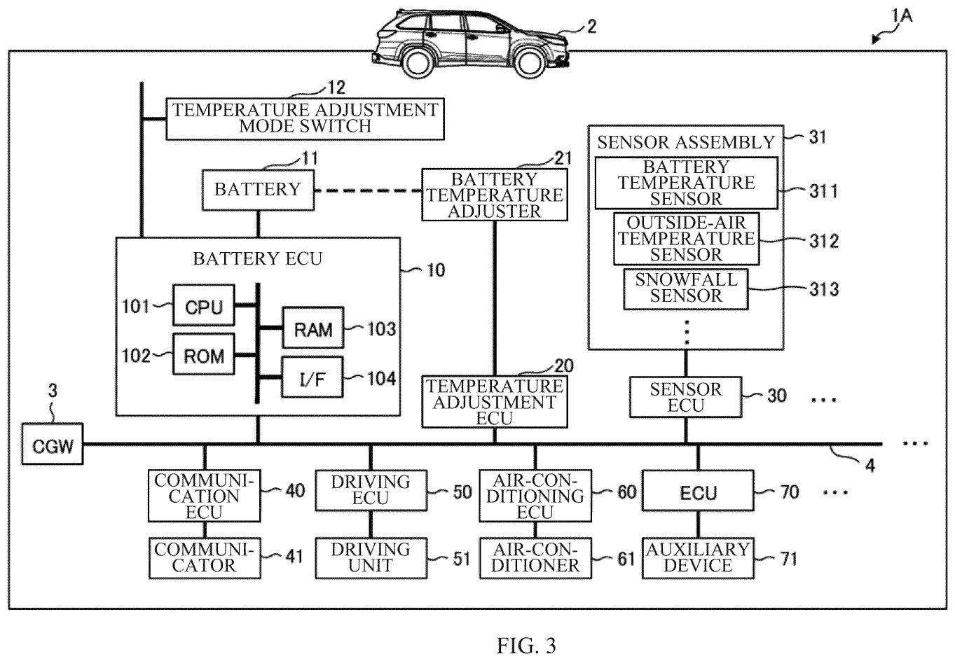

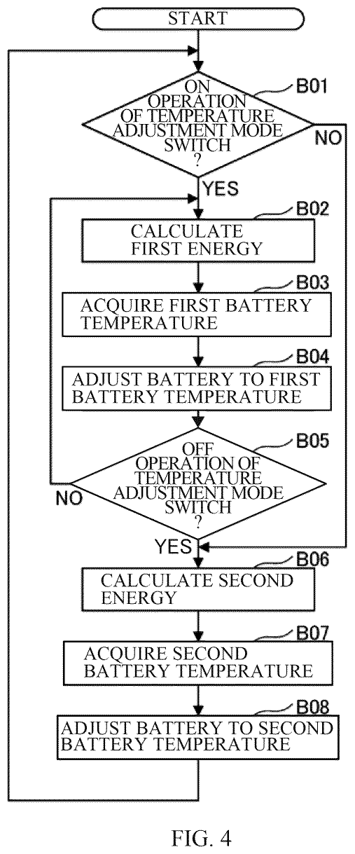

As illustrated in FIG. 3, the battery temperature control system 1A may include a temperature adjustment mode switch 12. In one embodiment, the temperature adjustment mode switch 12 may serve as a “switch”. In the present example embodiment, the temperature adjustment mode switch 12 may be displayed on a non-illustrated center information display (CID) provided in the vehicle 2, and may be configured to receive a touch operation. As illustrated in FIG. 3, the temperature adjustment mode switch 12 may be coupled to the battery ECU 10. The battery temperature control system 1A may perform the temperature adjustment of the battery 11 when the battery ECU 10 detects that the temperature adjustment mode switch 12 has been operated. The temperature adjustment will be described in detail later with reference to FIG. 4. The components of the battery temperature control system 1A, other than the temperature adjustment mode switch 12, may be similar to those of the battery temperature control system 1, and a description thereof is thus not given herein.

Next, a description will be given, with reference to FIG. 4, of exemplary control processing to be performed by the battery temperature control system 1A according to the modification example of the above-described embodiment.

The battery ECU 10 may monitor an ON operation on the temperature adjustment mode switch 12 (Step B01). The temperature adjustment mode switch 12 may be operated when the occupant of the vehicle 2 judges that it is difficult for the vehicle 2 to travel (i.e., the vehicle 2 is in the non-travelable state) or that it is unnecessary for the vehicle 2 to travel (i.e., the vehicle 2 is in a travel unnecessary state). If the ON operation on the temperature adjustment mode switch 12 is detected (Step B01: YES), the battery ECU 10 may calculate the first energy (Step B02). The first energy may be similar to that in the battery temperature control system 1, and the description thereof is thus not given herein. If the ON operation on the temperature adjustment mode switch 12 is not detected (Step B01: NO), the processing may proceed to Step B06.

After calculating the first energy upon detecting the ON operation on the temperature adjustment mode switch 12, the battery ECU 10 may acquire the first battery temperature that is a temperature of the battery 11 appropriate for the battery 11 to output the first energy (Step B03). The first battery temperature may be calculated based on the first energy as needed, or may be acquired from the electric power consumption map recorded in the battery ECU 10. After acquiring the first battery temperature, the battery ECU 10 may send data on the first battery temperature to the in-vehicle network 4. Upon receiving the data on the first battery temperature via the in-vehicle network 4, the temperature adjustment ECU 20 may adjust the temperature of the battery 11 to the first battery temperature (Step B04).

Thereafter, the battery ECU 10 may monitor an OFF operation of the temperature adjustment mode switch 12 (Step B05). The temperature adjustment of the battery 11 to the first battery temperature that is based on the first energy may be continuously performed until the OFF operation of the temperature adjustment mode switch 12 is detected (Step B05: NO).

If the ON operation on the temperature adjustment mode switch 12 is not detected in Step B01 (Step B01: NO) or if the OFF operation on the temperature adjustment mode switch 12 is detected in Step B05 (Step B05: YES), the battery ECU 10 may calculate the second energy (Step B06). The second energy may be similar to that in the battery temperature control system 1, and the description thereof is thus not given herein.

After calculating the second energy, the battery ECU 10 may acquire the second battery temperature appropriate for the battery 11 to output the second energy (Step B07). The second battery temperature may be calculated based on the second energy as needed, or may be acquired from the electric power consumption map recorded in the battery ECU 10. After acquiring the second battery temperature, the battery ECU 10 may send data on the secondary battery temperature to the in-vehicle network 4. Upon receiving the data on the second battery temperature via the in-vehicle network 4, the temperature adjustment ECU 20 may adjust the temperature of the battery 11 to the second battery temperature (Step B08), and the processing may return to Step B01. Thereafter, the control in Steps B01 to B08 described above may be repeated.

As described above with reference to FIG. 4, the battery temperature control system 1A according to the modification example may determine whether the vehicle 2 is in the non-travelable state or the travel unnecessary state, based on the detection as to whether the temperature adjustment mode switch 12 has been operated by the occupant of the vehicle 2. Upon detecting the ON operation on the temperature adjustment mode switch 12 and determining that the vehicle 2 is in the non-travelable state or the travel unnecessary state, the battery temperature control system 1A may adjust the temperature of the battery 11, based on the electric energy necessary to drive the auxiliary devices 71, including the air-conditioner 61, that are to be driven, without performing the temperature adjustment of the battery 11, based on the electric energy necessary to drive the driving unit 51.

As described above, the battery temperature control system 1A according to the modification example that includes the temperature adjustment mode switch 12 makes it possible to suppress unnecessary temperature adjustment of the battery 11, according to the intention of the occupant. This helps to reduce the electric power consumption in the temperature adjustment of the battery 11 without performing unnecessary temperature adjustment of the battery 11 when the vehicle 2 is in the travel unnecessary state because being stopped from traveling for a long stay, such as an overnight stay, of the occupant in the vehicle 2, with the auxiliary devices 71 such as the air-conditioner 61 driven, as well as when the vehicle 2 is in the non-travelable state due to stalling.

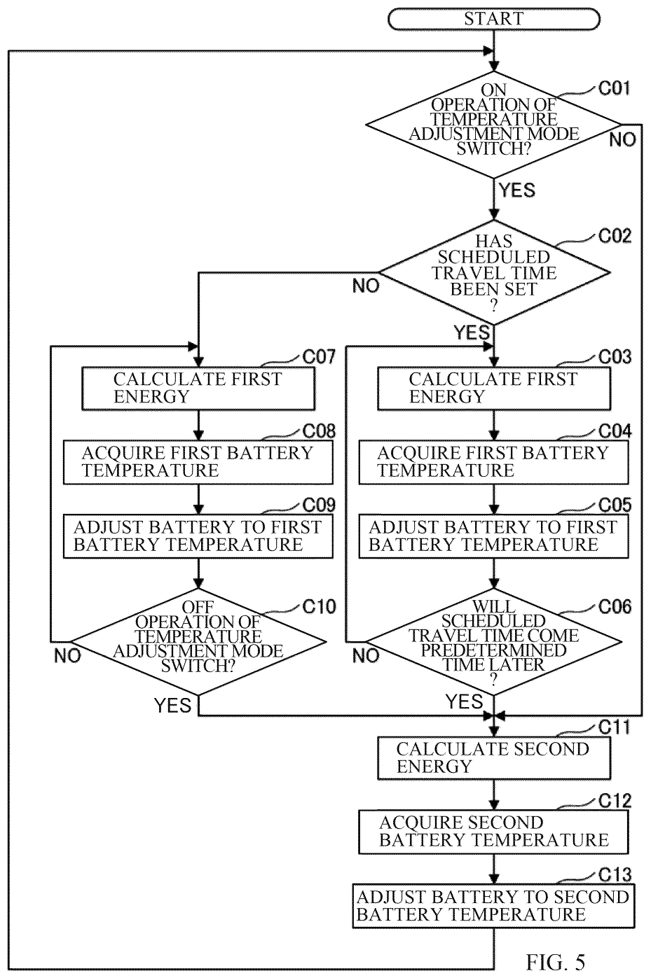

Further, the occupant of the vehicle 2 may be allowed to set a scheduled travel time during the ON operation on the temperature adjustment mode switch 12. A description will now be given, with reference to FIG. 5, of exemplary control processing to be performed by the battery temperature control system 1A to set the scheduled travel time. Note that a description of part of the control processing illustrated in FIG. 5 similar to that in FIG. 4 is not given herein.

The battery ECU 10 may monitor the ON operation on the temperature adjustment mode switch 12 (Step C01). If the ON operation on the temperature adjustment mode switch 12 is detected (Step C01: YES), the battery ECU 10 may determine whether the scheduled travel time has been set (Step C02). The occupant of the vehicle 2 may be allowed to set the scheduled travel time during the ON operation on the temperature adjustment mode switch 12.

If it is determined that the scheduled travel time has been set by the occupant of the vehicle 2 during the ON operation on the temperature adjustment mode switch 12 and that the scheduled travel time has been set (Step C02: YES), the battery ECU 10 may calculate the first energy (Step C03). The first energy may be similar to that in the battery temperature control system 1, and the description thereof is thus not given herein. After calculating the first energy, the battery ECU 10 may acquire the first battery temperature appropriate for the battery 11 to output the first energy (Step C04). The first battery temperature may be calculated based on the first energy as needed, or may be acquired from the electric power consumption map recorded in the battery ECU 10.

After acquiring the first battery temperature, the battery ECU 10 may send the data on the first battery temperature to the in-vehicle network 4. Upon receiving the data on the first battery temperature via the in-vehicle network 4, the temperature adjustment ECU 20 may adjust the temperature of the battery 11 to the first battery temperature (Step C05).

Based on the scheduled travel time set by the occupant of the vehicle 2, the battery ECU 10 may determine whether the scheduled travel time will come a predetermined time later (Step C06). The predetermined time may be any period of time enough to adjust the temperature of the battery 11 to the second battery temperature by the scheduled travel time. In some embodiments, the predetermined time may be set to about five to ten minutes. If the battery ECU 10 determines that the scheduled travel time will not come the predetermined time later (Step C06: NO), the processing may return to Step C03, and the battery ECU 10 may continue adjusting the temperature of the battery 11 to the first battery temperature that is based on the first energy.

If it is determined that the scheduled travel time will come the predetermined time later (Step C06: YES) or if it is not determined that the ON operation on the temperature adjustment mode switch 12 is detected in Step C01 (Step C01: NO), the battery ECU 10 may calculate the second energy (Step C11). Thereafter, Steps C11 to C13 similar to Steps B06 to B08 described above with reference to FIG. 4 may be performed. If it is not determined that the scheduled travel time has been set by the occupant of the vehicle 2 during the ON operation on the temperature adjustment mode switch 12 (Step C02: NO), the processing may proceed to Step C07. Thereafter, Steps C07 to C10 similar to Step B02 to B05 described above with reference to FIG. 4 may be performed.

According to the battery temperature control system 1A described above with reference to FIG. 5, the occupant of the vehicle 2 may be allowed to set the scheduled travel time. Upon detecting the ON operation on the temperature adjustment mode switch 12 and determining that the vehicle 2 is in the non-travelable state or the travel unnecessary state, the temperature of the battery 11 may be adjusted to the first battery temperature that allows the auxiliary devices 71 excluding the driving unit 51 to be driven. When it is determined that the scheduled travel time has been set, the temperature of the battery 11 may be adjusted to the second battery temperature that allows the auxiliary devices 71 including the driving unit 51 to be driven by the scheduled travel time. This makes it possible to adjust the temperature of the battery 11 to the second battery temperature that allows the vehicle 2 to travel, by a departure time in a day after an overnight stay in the vehicle 2, for example. It is therefore possible to suppress unnecessary temperature adjustment of the battery 11 and to cause the vehicle 2 to start traveling without bothering the occupant.

As described in detail above with reference to the drawings, the battery temperature control systems 1 and 1A according to the above-described example embodiments each include the battery 11, the auxiliary devices 71, and the processor (ECU). The auxiliary devices 71 includes at least the air-conditioner 61. The processor (ECU) determines whether the vehicle 2 is in the non-travelable state or the travel unnecessary state. Upon determining that the vehicle 2 is in the non-travelable state or the travel unnecessary state, the processor calculates the first energy necessary to drive the auxiliary devices 71, and adjusts the temperature of the battery to the first battery temperature appropriate for the battery 11 to output the first energy. This control helps to reduce the electric power consumption of the battery 11 without performing unnecessary temperature adjustment of the battery 11 based on the electric energy necessary to drive the driving unit 51 in the condition where the vehicle 2 is in the non-travelable state or the travel necessary state.

Further, according to the battery temperature control system 1 of the above-described example embodiment, the processor (ECU) may estimate the time of elimination of the non-travelable state of the vehicle 2, calculate the second energy necessary to cause the vehicle 2 to travel and to drive the auxiliary devices 71, and adjust the temperature of the battery to the second battery temperature that is based on the second energy by the estimated time. This control makes it possible to adjust the temperature of the battery 11 of the vehicle 2 in the non-travelable state due to stalling, to the second battery temperature that allows the driving unit 51 to be driven, by the time when the vehicle will be brought into a travelable state. It is therefore possible for the vehicle 2 to enhance travel convenience.

Further, according to the battery temperature control system 1 of the above-described example embodiment, the processor (ECU) may determine that the vehicle 2 is in the non-travelable state or the travel unnecessary state upon detecting the ON operation on the temperature adjustment mode switch 12. This determination allows the occupant of the vehicle 2 to change the temperature adjustment of the battery 11, according to his/her intention. This helps to reduce the electric power consumption in the temperature adjustment of the battery 11 without performing unnecessary temperature adjustment of the battery 11 when the vehicle 2 is in the travel unnecessary state because being stopped from traveling for a long stay, such as an overnight stay, of the occupant in the vehicle 2, with the auxiliary devices 71 such as the air-conditioner 61 driven, as well as when the vehicle 2 is in the non-travelable state due to stalling.

Although some embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. does not denote any order or importance, but rather the terms first, second, etc. are used to distinguish one element from another.

The terms “substantially”, “approximately”, “about”, and its variants having a similar meaning thereto are defined as being largely but not necessarily wholly what is specified as understood by one of ordinary skill in the art.

The terms “disposed on/provided on/formed on” and its variants having a similar meaning thereto as used herein refer to elements disposed directly in contact with each other or indirectly by having intervening structures therebetween.

According to the battery temperature control system according to the above-described example embodiments of the disclosure, it is possible in the condition where the vehicle is in the non-travelable state or the travel unnecessary state to adjust the temperature of the battery to a temperature appropriate for the battery to output the necessary electric energy without performing the battery temperature adjustment based on the electric energy necessary to cause the vehicle to travel, to thereby reduce the electric power consumption of the battery in the battery temperature adjustment. This helps to secure the comfortability of the occupant even at the occurrence of prolonged stalling of the vehicle.

One or more of the battery ECU 10, the temperature adjustment ECU 20, and the battery temperature adjuster 21 illustrated in FIGS. 1 and 3 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the battery ECU 10, the temperature adjustment ECU 20, and the battery temperature adjuster 21 illustrated in FIGS. 1 and 3. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the battery ECU 10, the temperature adjustment ECU 20, and the battery temperature adjuster 21 illustrated in FIGS. 1 and 3.

1. A battery temperature control system configured to be applied to a vehicle, the battery temperature control system comprising:
a battery;
an auxiliary device comprising an air-conditioner; and
a processor configured to determine whether the vehicle is in a non-travelable state or a travel unnecessary state, wherein
the processor is configured to, upon determining that the vehicle is in the non-travelable state or the travel unnecessary state,
calculate first energy necessary to drive the auxiliary device, and
adjust a temperature of the battery to a first battery temperature appropriate for the battery to output the first energy.

2. The battery temperature control system according to claim 1, wherein
the processor is configured to
estimate a time of elimination of the non-travelable state of the vehicle,
calculate second energy necessary to cause the vehicle to travel and to drive the auxiliary device, and
adjust the temperature of the battery to a second battery temperature by the time estimated, the second battery temperature being appropriate for the battery to output the second energy.

3. The battery temperature control system according to claim 1, wherein the processor is configured to, after estimating a time of elimination of the non-travelable state of the vehicle, drive the auxiliary device, based on the time and a state of charge of the battery.

4. The battery temperature control system according to claim 1, wherein the processor is configured to, upon detecting an ON operation on a switch configured to change a temperature adjustment mode of the battery, determine that the vehicle is in the non-travelable state or the travel unnecessary state.

5. A vehicle comprising the battery temperature control system according to claim 1.

6. A vehicle comprising the battery temperature control system according to claim 2.

7. A vehicle comprising the battery temperature control system according to claim 3.

8. A vehicle comprising the battery temperature control system according to claim 4.
